(19) United States
(12) Patent Application Publication
(10) Pub. No.: US 2009/0181616 A1
(43) Pub. Date: Jul. 16, 2009

(54) FREQUENCY SHARING IN A COMMUNICATION SYSTEM

(76) Inventors: Kevin Hodson, Sandy (GB); Donald Lester, Letchworth Garden City (GB)

Correspondence Address: LOWRIE, LANDO & ANASTASI, LLP, ONE MAIN STREET, SUITE 1100, CAMBRIDGE, MA, 02142, US

(21) Appl. No.: 12/247,419

(22) Filed: Oct. 8, 2008

(30) Foreign Application Priority Data
Jan. 10, 2008 (GB) 0800385.7

(51) Int. Cl. H04B 7/185

(52) U.S. Cl. 455/12.1; 375/267

(57) ABSTRACT

The invention provides a communication system and method of communication. The communication system includes a satellite transmitter arranged to transmit a first signal to be received within a predefined geographical area by a satellite receiver, and a terrestrial transmitter arranged to transmit a second signal to be received within the predefined geographical area by a terrestrial receiver. The first and second signals share a common radio frequency band and the system is arranged such that the first signal is received at an antenna associated with the satellite receiver at a first angle from the horizontal, the first angle being greater than a second angle from the horizontal at which the second signal is received at the antenna. This enables the satellite receiver to distinguish the first signal from the second signal. The terrestrial transmitter and receiver are also arranged to operate a multiple-input and multiple-output MIMO system enabling the terrestrial receiver to distinguish the second signal from the first signal.

The invention relates to frequency sharing in a communication system and a method of communication, particularly but not exclusively to a system and method in which a common radio transmission frequency band can be shared by two communication signals broadcast over the same geographical area.

It is a generally accepted feature of radio communications that different communication systems in a given geographical area are required to operate at different frequencies, in order to avoid mutual interference. In the case of satellite communications, satellites generally transmit signals over a wide geographical area having relatively low power flux densities. This means that receiving equipment must be highly sensitive, making it difficult or impossible to use the satellite system in conjunction with a terrestrial communication system operating in the same geographical area and in the same frequency band.

Accordingly, most satellite communication systems operate in dedicated frequency bands, coordinated world-wide through the International Telecommunications Union (ITU).

Following the forthcoming switchover from analogue to digital television broadcasts, a significant range of Ultra High Frequency (UHF) bands will become available. This, combined with advances in technology providing satellites with the capability of increasingly precise transmission coverage and greater power flux densities, would enable the low cost delivery via satellite of UHF signals such as digital television signals across wide geographical areas.

However, a satellite provides a near uniform signal strength over a predetermined coverage area, which precludes other terrestrial communications systems from operating on the same frequencies within that area.

The present invention aims to address these issues.

According to the invention, there is provided a communication system comprising a satellite transmitter arranged to transmit a first signal, wherein the first signal can be received within a predefined geographical area, a satellite receiver for receiving the first signal, a terrestrial transmitter arranged to transmit a second signal, wherein the second signal can be received within the predefined geographical area, and a terrestrial receiver for receiving the second signal, wherein the first and second signals share a common radio frequency band, the system being arranged such that the first signal is received at an antenna associated with the satellite receiver at a first angle from the horizontal and the second signal is received at the antenna at a second angle from the horizontal, the first angle being greater than the second angle to enable the satellite receiver to distinguish the first signal from the second signal, and the terrestrial transmitter and receiver are arranged to operate a multiple-input and multiple-output MIMO system enabling the terrestrial receiver to distinguish the second signal from the first signal.

The invention therefore provides a system in which a satellite receiver can avoid interference from a terrestrial transmission in the same frequency band based on the angle at which a satellite transmission is received. This enables the satellite receiver to have relatively simple signal processing circuitry, as distinguishing between the satellite and terrestrial transmissions is largely performed at the antenna. A terrestrial system can use MIMO technology to mitigate degradations in signal quality caused by the satellite transmission.

The antenna associated with the satellite receiver can be a directional antenna having a gain with respect to the first signal of at least approximately 15 dB greater than the gain with respect to the second signal and/or can have an overall gain of at least 12 dBi.

The terrestrial transmitter can be arranged to have one or more antennas and the terrestrial receiver can be arranged to have two or more antennas.

The terrestrial transmitter can comprise a base station transceiver and the terrestrial receiver can comprise a user transceiver, wherein the user transceiver is arranged to transmit a third signal to be received by the base station transceiver. The system can accordingly be arranged such that the third signal is received at the antenna associated with the satellite receiver at a third angle from horizontal, the first angle being greater than the third angle to enable the satellite receiver to distinguish the first signal from the third signal.

The first signal can comprise a digital multi-media broadcast, for example a signal compliant with DVB-T or DVB-H formats and the second and/or third signals can comprise a mobile telecommunications signal, for example a signal compliant with the WiMAX MIMO format.

The MIMO system can be arranged to include one or more feedback loops between the terrestrial receiver and the terrestrial transmitter. Accordingly, fed back information concerning the circumstances at either the terrestrial receiver or the terrestrial transmitter can be used to improve the transmission channel of the second and/or third signals.

The satellite transmitter can be arranged to transmit from a geostationary orbit.

The first angle from the horizontal can be an angle between approximately 50 and 90 degrees.

The common radio frequency band can comprise an ultra high frequency UHF band. Preferably, the present invention can make use of the frequency bands made available by the analogue to digital switchover, which comprise frequencies in the range of 470 MHz to 862 MHz.

According to the invention, there is also provided a method of communication comprising transmitting a first signal to a predefined geographical area, the first signal to be received by a satellite receiver, transmitting a second signal to the predefined geographical area, the second signal to be received by a terrestrial receiver, the first and second signals sharing a common radio frequency band, receiving the first signal at an antenna associated with the satellite receiver at a first angle from the horizontal, receiving the second signal at the antenna at a second angle from the horizontal, the first angle being greater than the second angle, distinguishing the first signal from the second signal based on the difference between the first and second angles, and operating a multiple-input and multiple-output MIMO system to enable the terrestrial receiver to distinguish the second signal from the first signal.

Embodiments of the invention will now be described, by way of example, with reference to the accompanying drawings, in which:

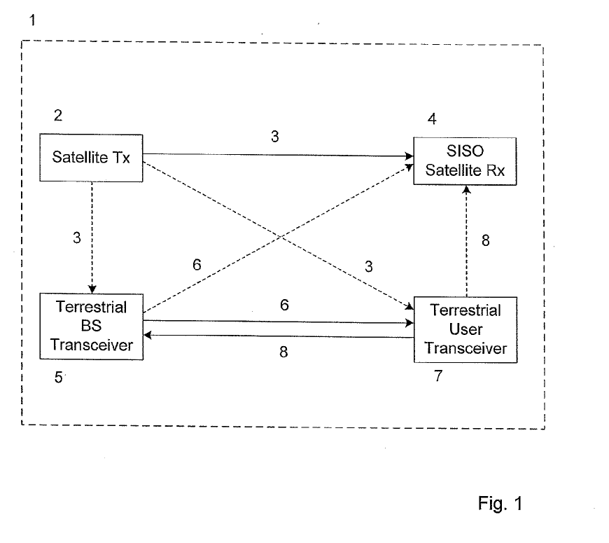

FIG. 1 is a schematic illustration of a communication system according to the present invention;

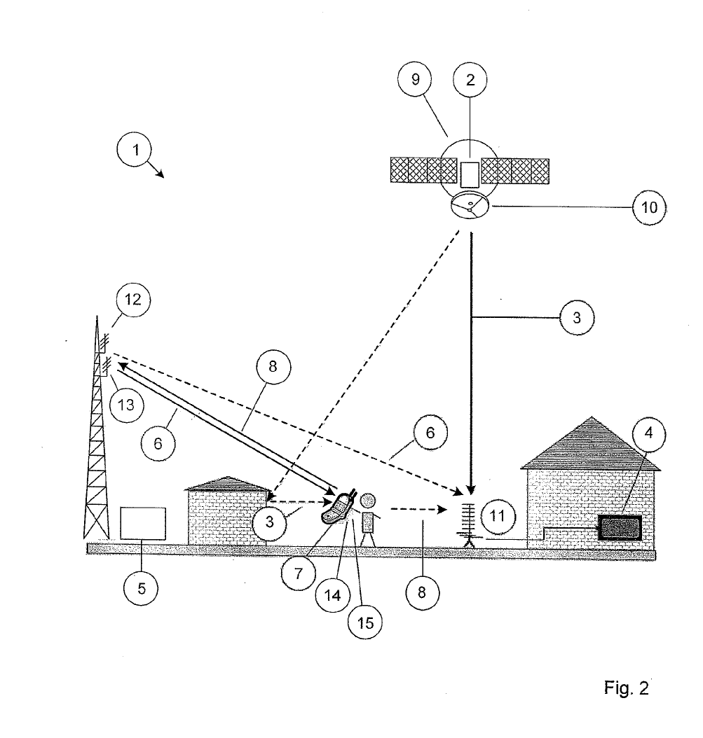

FIG. 2 illustrates the components of the communication system of FIG. 1 in more detail;

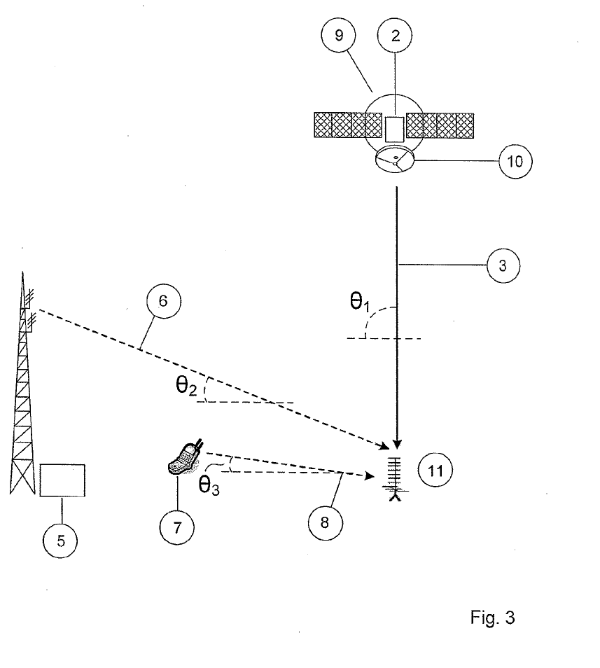

FIG. 3 illustrates the angles of incidence of satellite and terrestrial transmissions received at a ground antenna of the communication system of FIG. 1;

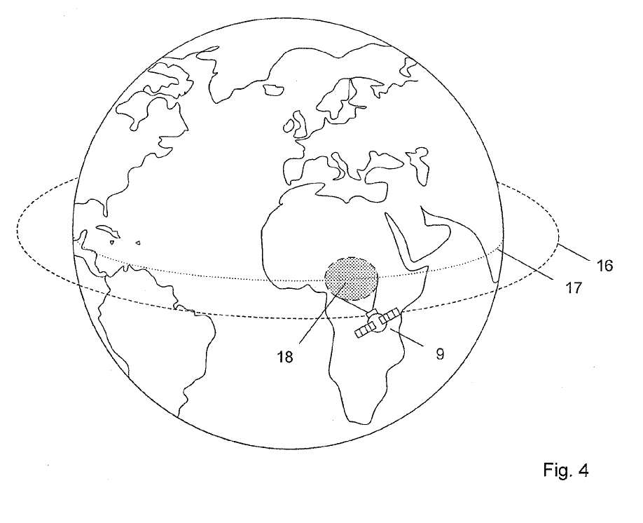

FIG. 4 illustrates a geostationary satellite orbit used by the satellite of the communication system of FIG. 1; and

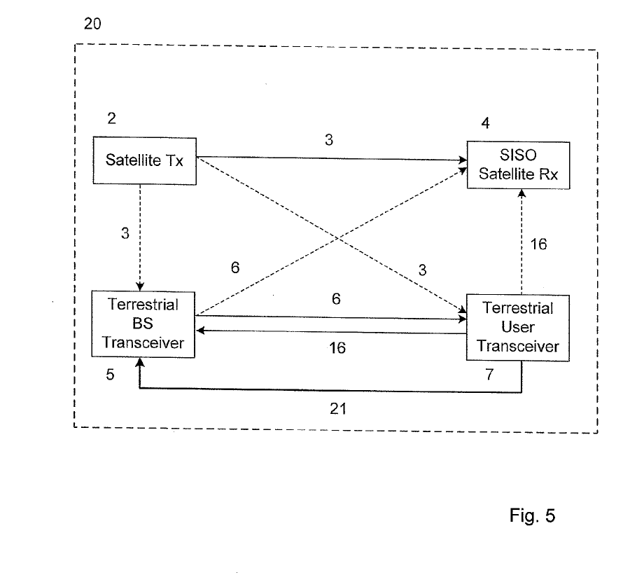

FIG. 5 is a schematic illustration of a further communication system according to the present invention.

Referring to FIG. 1, a communication system 1 includes a satellite transmitter 2 arranged to transmit a satellite signal 3 to a satellite receiver 4. The satellite signal is, in the present example, a DVB-T compliant digital multi-media broadcast signal, received at a satellite television receiver 4, for instance a set-top box.

The system 1 also includes a ground or terrestrial base-station transceiver 5 arranged to transmit an outward terrestrial signal 6 to a terrestrial user transceiver 7. The terrestrial user transceiver 7 is arranged to transmit a return terrestrial signal 8 to the base-station transceiver 5. The outward and return terrestrial signals 6, 8 are, in the present example, both multiple-input and multiple-output (MIMO) WiMAX compliant signals.

The satellite signal 3 and terrestrial signals 6, 8 accordingly carry independent information.

The satellite signal 3 and terrestrial signals 6, 8 share a common radio frequency band and, in particular, can be arranged to share the same carrier frequency or carrier frequencies within the frequency band. In the present example, the common frequency band is the ultra-high frequency (UHF) band, in particular frequencies in the range 470-862 MHz. This includes frequencies which will become available as a result of the switchover from analogue to digital television broadcasting.

The satellite transmitter 2 and the terrestrial transceivers 5, 7 transmit their respective signals 3, 6, 8 such that the satellite signal 3 and at least one of the outward and return terrestrial signals 6, 8 can be received anywhere within a predefined geographical area. The satellite receiver 4 and terrestrial transceivers 5, 7 are each located within this area and therefore, to a certain extent, the satellite signal 3 is also received at the terrestrial transceivers 5, 7, and at least one of the terrestrial signals 6, 8 is also received at the satellite receiver 4. The resulting additional signal paths are illustrated by dashed arrows in FIG. 1.

The satellite receiver 4 is, in the present example, a single-input and single-output (SISO) receiver, thus using only a single antenna to receive the satellite signal 3, which is transmitted from a single antenna at the satellite. In order for the satellite receiver 4 to distinguish the satellite signal 3 from either or both of the terrestrial signals 6, 8, the system 1 is arranged such that the satellite signal 3 arrives at the satellite receiver 4 at a larger angle from horizontal, or elevation angle, than the terrestrial signals 6, 8. The antenna at the satellite receiver 4 is directed so as to maximise its sensitivity to the satellite signal 3 and to minimise its sensitivity towards the terrestrial signals 6, 8, based on the different directions from which these signals are received. As a result, the terrestrial signals 6, 8 arriving at the receiver 4 are significantly attenuated in relation to the satellite signal 3.

The terrestrial user transceiver 7 and base station transceiver 5 are, in the present example, multiple-input and multiple-output (MIMO) transceivers, using multiple antennas to receive the respective outward and return terrestrial signals 6, 8. MIMO is well known in the art as a means for exploiting diversity domains such as spatial diversity, code diversity and polarisation diversity to improve the robustness and/or capacity of a communication system.

A MIMO system is generally characterised by multiple transmit antennas and multiple receive antennas. For a system with p transmit antennas and q receive antennas, there are p×q channels between the transmitter and the receiver. Therefore, by using a MIMO system at the base station and user transceivers 5, 7 of the communication system 1, degradations in the signal quality of the terrestrial signals 6, 8 caused by interference from the satellite signal 3 can be mitigated by signal processing, in the present example performed at each of the terrestrial transceivers 5, 7. The processing can, for instance, exploit the diversity of the multiple channels by selecting the best channels available.

FIG. 2 illustrates the communication system 1 of FIG. 1 in more detail.

Referring to FIG. 2, a satellite 9 includes the satellite transmitter 2 connected to a satellite antenna 10 for broadcasting the satellite signal 3 to the satellite receiver 4, the satellite signal 3 being received at the satellite receiver 4 via a ground antenna 11. The satellite 9 is, in the present example, adapted for use with UHF radio signals.

The satellite transmitter 2 is arranged to provide a relatively powerful signal compared to conventional satellite transmitters. In the present example, the satellite transmitter 2 appears as an isotropic 5MW source, within only a predefined coverage area, providing a signal flux density on the Earth's surface of about −96 dBW/m². The predefined coverage area, in the present example, encompasses the predefined geographical area in which at least one of the outward and return terrestrial signals 6, 8 can be received.

As illustrated in FIG. 3, the satellite signal 3 is received at the ground antenna 11 at an angle θ₁, which is, in the present example, between 50 and 90 degrees from the horizontal. The terrestrial signals 6, 8, on the other hand, are received at the ground antenna 11 at respective angles θ₂, θ₃ not exceeding 10 degrees from the horizontal.

The ground antenna 11 is a directional antenna, in the present case a Yagi-Uda antenna, arranged to point to the satellite 9 such that it has a lower sensitivity to signals received from sources at low angles of elevation. The ground antenna 11 preferably has a gain of between 12 and 20 dBi. As a result of the different elevation angles θ₁, θ₂, θ₃ at which the satellite and terrestrial signals 3, 6, 8 are received, the ground antenna is also arranged to have a gain with respect to the satellite signal 3 of at least 15 dB greater than that with respect to the terrestrial signals 6, 8.

Although, in the present example, the ground antenna 11 has been described as a Yagi-Uda antenna, other directional antennas could be used having different forward gains and/or different directional properties, such as other variations in gain according to the angles of incidence of received signals at the antenna. The satellite receiver 4 is preferably relatively insensitive compared to conventional satellite receivers, and has a relatively high noise floor.

The communication system 1 is arranged to operate in regions of the world where the elevation angle to a satellite 9 is at least 50 degrees. For instance, high elevation angles can be achieved in equatorial regions such as large parts of Africa, using satellites in geostationary orbits. The invention can also be used with satellites in alternative orbits such as the Molniya orbit. Satellites in the Molniya orbit can, for instance, be used to provide the satellite signal 3 of the present invention to high northern latitudes such as parts of the Russian Federation and Canada.

Referring to FIG. 4, a geostationary orbit of the satellite 9 of the communication system 1 is illustrated, the satellite 9 following a trajectory 16 directly above the Earth's equator 17. The satellite 9 is arranged to have an orbital period matching the Earth's sidereal rotation period, and to orbit at an altitude of approximately 35,786 km above the mean sea level. The satellite signal 3 is, in this example, provided over a geographical area 18 located in an equatorial region of Africa.

Referring again to FIG. 2, the terrestrial base-station transceiver 5 is connected to first and second base station antennas 12, 13, which each transmit the outward terrestrial signal 6 to the user terrestrial transceiver 7, in this case a mobile device, and receive the return terrestrial signal 8 from the mobile device 7. The mobile device 7 includes first and second user terrestrial antennas 14, 15 for receiving the terrestrial signal 6 and for transmitting the return terrestrial signal 8 to the base-station 5. The antennas 12, 13, 14, 15 are referred to as receive antennas when acting to receive a transmitted signal and as transmit antennas when acting to transmit a signal.

The channel model for each direction of transmission within the MIMO system can be expressed as:

y=H·x+n

where x is a vector of size p and represents the transmitted terrestrial signal, y is a vector of size q representing the received signal, H is a matrix that models the MIMO channel of size p×q and n is a vector of size q representing noise in the MIMO channel. All vector and matrix elements are complex.

The satellite signal 3 and terrestrial signals 6, 8, or the SISO and MIMO signals, can be distinguished by the MIMO terrestrial transceivers 5, 7 based on, for example, a value contained in the transmitted signals, such as a unique word or similar. This could be, for instance, a code word transmitted as part of the outward and/or return signals 6, 8, or generally repeating data, for instance that relating to a digital information service such as an electronic program guide associated with the multi-media broadcast signal 3.

Each of the MIMO terrestrial transceivers 5, 7 is arranged to adjust the complex elements in H in such a manner that the respective wanted MIMO terrestrial signal 6, 8 (one or more elements in y) is maximised and unwanted SISO satellite signal 3 (at least one element in y) is minimised. The SISO satellite signal 3 may be received in a direct path from the satellite transmitter 2, or alternatively may be received as a signal reflected from a building or other structure, as illustrated in FIG. 2. The adjustment is a continuous process as it is assumed that the MIMO channel is time varying.

To assist this process, one of the p receive antennas 12, 13 or 14, 15 may be arranged to receive more of the unwanted satellite signal 3 than the wanted terrestrial signal. This enables properties of the unwanted satellite signal 3 to be determined such that its effects on the received signal can be cancelled out.

FIG. 5 illustrates a further communication system 20 according to the invention, in which a feedback path 21 is provided between the user terrestrial transceiver 7 and the terrestrial base station transceiver 5. Only one direction of transmission is shown in the illustrated example, although a feedback path can also be provided from the terrestrial base station transceiver 5 to the user terrestrial transceiver 7, either in place of or in addition to the illustrated feedback path 21. The feedback path 21 provides the terrestrial base station transceiver 5 with knowledge of the conditions at the user transceiver 7, which can help to mitigate any degradations in the signal quality of the outward terrestrial signal 6, for instance those caused by the satellite signal 3. The terrestrial base station transceiver 5 would accordingly include signal processing circuitry for this purpose. Such systems are referred to in the art as cooperative MIMO systems.

Whilst specific examples of the invention have been described, the scope of the invention is defined by the appended claims and not limited to the examples. The invention could therefore be implemented in other ways, as would be appreciated by those skilled in the art.

For instance, the example of FIG. 2 includes two transmit and receive antennas 12, 13 at the base station 5 and two transmit and receive antennas 14, 15 at the user terrestrial transceiver 7. However, in general, the MIMO system may have one or more antennas arranged to transmit and two or more antennas arranged to receive for each of the transceivers 5, 7 employed. MIMO signal processing need not be performed at both transceivers 5, 7, but could, for instance, be performed at only one of the transceivers 5, 7.

Also, the invention has been described as providing a digital multimedia broadcast signal compliant with DVB-T and a MIMO WiMax compliant signal, but could alternatively or additionally be used with other types of communication signals, including both digital and analogue signals. For instance, the multimedia broadcast signal can alternatively be compliant with DVB-H or an alternative digital or analogue format. The satellite signal 3 and terrestrial signals 6, 8 could, in one example, be the same type of signal, for instance a digital television signal, but carrying different content. Also, although outward and return terrestrial signals 6, 8 are described, the MIMO communication link may instead be a one-way link, for instance including only a terrestrial broadcast signal 6 without a return signal 8. In this case, the base station transceiver can instead include only a transmitter and one or more corresponding transmit antennas and the user terrestrial transceiver can instead include only a receiver and two or more corresponding receive antennas. The mobile device 7 may, rather than being a mobile device, be a fixed device.

Additionally, whilst the satellite signal 3 has been described as transmitted using a SISO configuration, this is not essential. Other configurations could be used, for instance a MIMO configuration. Furthermore, although the satellite signal 3 has been described as a one-way broadcast, alternatively the satellite receiver 4 could be additionally configured to transmit signals back to the satellite 9. Alterations would also be required to other components of the communication system 1, such as the ground antenna 11, as would be appreciated by those skilled in the art.

It is recognised that reception of the satellite signal 3 at a satellite receiver 4 located in the vicinity of either of the terrestrial transceivers 5, 7 may be problematic due to high signal strengths from either or both of them. This restriction can be mitigated either by planning for which service is provided for a given area or by replacing the satellite SISO system described herein with a MIMO satellite receiver.

1. A communication system comprising:
a satellite transmitter arranged to transmit a first signal, wherein the first signal can be received within a predefined geographical area;
a satellite receiver for receiving the first signal;
a terrestrial transmitter arranged to transmit a second signal, wherein the second signal can be received within the predefined geographical area; and
a terrestrial receiver for receiving the second signal, wherein:
the first and second signals share a common radio frequency band;
the system is arranged such that the first signal is received at an antenna associated with the satellite receiver at a first angle from the horizontal and the second signal is received at the antenna at a second angle from the horizontal, the first angle being greater than the second angle to enable the satellite receiver to distinguish the first signal from the second signal; and
the terrestrial transmitter and receiver are arranged to operate a multiple-input and multiple-output MIMO system to enable the terrestrial receiver to distinguish the second signal from the first signal.

2. A communication system according to claim 1, wherein the antenna is a directional antenna having a gain with respect to the first signal of at least approximately 15 dB greater than the gain with respect to the second signal.

3. A communication system according to claim 1, wherein the antenna has an overall gain of at least 12 dBi.

4. A communication system according to claim 1, wherein the terrestrial transmitter is arranged to have one or more antennas and the terrestrial receiver is arranged to have two or more antennas.

5. A communication system according to claim 1, wherein the terrestrial transmitter comprises a base station transceiver and the terrestrial receiver comprises a user transceiver, and wherein the user transceiver is arranged to transmit a third signal to be received by the base station transceiver.

6. A communication system according to claim 5, wherein the system is arranged such that the third signal is received at the antenna associated with the satellite receiver at a third angle from horizontal, the first angle being greater than the third angle to enable the satellite receiver to distinguish the first signal from the third signal.

7. A communication system according to claim 1, wherein the first signal comprises a digital multimedia broadcast.

8. A communication system according to claim 7, wherein the first signal is compliant with the DVB-T or DVB-H formats.

9. A communication system according to claim 1, wherein the second signal comprises a mobile telecommunications signal.

10. A communication system according to claim 9, wherein the second signal comprises a signal compliant with the WiMAX MIMO format.

11. A communication system according to claim 1, wherein the MIMO system is arranged to include one or more feedback loops between the terrestrial receiver and the terrestrial transmitter.

12. A communication system according to claim 1, wherein the satellite transmitter is arranged to transmit from a geostationary orbit.

13. A communication system according to claim 1, wherein the first angle from the horizontal is an angle between approximately 50 and 90 degrees.

14. A communication system according to claim 1, wherein the common radio frequency band comprises an ultra high frequency UHF band.

15. A communication system according to claim 14, wherein the common radio frequency band comprises frequencies in the range of 470 MHz to 862 MHz.

16. A method of communication comprising:
transmitting a first signal to a predefined geographical area, the first signal to be received at a satellite receiver;
transmitting a second signal to the predefined geographical area, the second signal to be received by a terrestrial receiver, the first and second signals sharing a common radio frequency band;
receiving the first signal at an antenna associated with the satellite receiver at a first angle from the horizontal;
receiving the second signal at the antenna at a second angle from the horizontal, the first angle being greater than the second angle;
distinguishing the first signal from the second signal based on the difference between the first and second angles; and
operating a multiple-input and multiple-output MIMO system to enable the terrestrial receiver to distinguish the second signal from the first signal.

17. A method according to claim 16, wherein the MIMO system is arranged to include one or more feedback loops between the terrestrial receiver and the terrestrial transmitter.

18. A method according to claim 16, comprising transmitting the first signal from a geostationary orbit.
